(19) United States
(12) Patent Application Publication
(10) Pub. No.: US 2015/0310107 A1
(43) Pub. Date: Oct. 29, 2015

(54) VIDEO AND AUDIO CONTENT SEARCH ENGINE

(71) Applicant: Shadi A. Alhakimi, Sana'a (YE)

(72) Inventor: Shadi A. Alhakimi, Sana'a (YE)

(21) Appl. No.: 14/690,398

(22) Filed: Apr. 18, 2015

(30) Foreign Application Priority Data
Apr. 24, 2014 (YE) 586321

(51) Int. Cl. G06F 17/30

(52) U.S. Cl. CPC G06F 17/30864; G06F 17/3002; G06F 17/30091

(57) ABSTRACT

A method is provided for indexing video and audio content on the internet, comprising: searching the internet for files containing audio or video (A/V) content; obtaining text associated with a file containing A/V content; generating a first searchable index of the associated text; storing the first searchable index in a database; processing audio of files that do not contain associated text through a speech-to-text recognition module to generate first processed associated text; generating a second searchable index of the first processed associated text; storing the second searchable index with the searchable first index in the database; and making the first and second searchable indexes stored in the database available to users who submit search request terms to be matched with the associated text and first processed associated text in the database. Rather than storing sounds as part of a speech-to-text training process, Cymatics images may be created and stored.

### RELATED APPLICATION DATA

The present application is related to commonly-owned and co-pending Yemeni Application Serial Number 586321 filed on Apr. 24, 2014, which application (with its English translation) is attached hereto as Attachment A and incorporated herein by reference in its entirety.

### TECHNICAL FIELD

The present invention relates generally to web searching and, in particular, to searching for video and audio content.

### BACKGROUND ART

Day after day, technology has been gradually affecting our life socially, academically, and in countless other fields. In addition, people tend to invent new technologies that not only help people in their daily lives, but also make people think that nothing is impossible to achieve. One of the most impressive technological ideas in the early 1990's was the search engine, which has made it easier for people to dive right into the Internet. However, there are hundreds of millions of pages available, most of them titled according to the whim of the author, and almost all of them sitting on servers with cryptic names. When one needs to know about a particular subject, one visits an Internet (World Wide Web) search engine.

Before a search engine can indicate where a file or document is, file or document must be found. FIG. 1 Illustrates the general concept used by search engines. To find information on the hundreds of millions of Web pages that exist, a search engine employs special software robots, called “spiders” 10, that are provided with website URLs and “crawl” throughout the Web 12. The spider builds lists 14 of the words and their location on the Web. In order to build and maintain a useful list of words, a search engine's spiders have to look at a lot of pages and then index the words 16. The information is typically encoded or compressed to save space 18 and stored in a database 20. When a user enters search terms, the search engine attempts to match the search terms to words stored in the database. Each result returned to the user by the search engine, which includes the corresponding URL, is ranked by the probability that the referenced Web location is one which meets the user's search criteria.

However, searching through the web for video and audio files that meets a searcher's criteria is becoming more challenging as people's expectations are becoming increasingly greater. Despite all the efforts to improve the capability of search engines, video and audio content remains very difficult to search, regardless of the search engine used, other than by the title of the file or any attached description or metadata.

One approach that purports to improve current speech-to-text technology relies on system training for specific users, which is used in local systems such as “windows speech.” Another approach relies on online servers and improves in the accuracy every time users use the system. Such an approach is implemented in Apple Corporation's Siri®.

One patent that addressed the specific issue of video and audio file searching was entitled “Audio Content Search Engine” (U.S. Pat. No. 7,983,915). The patent, briefly, discloses a method of generating an audio content index for use by a search engine. The method includes determining a phoneme sequence based on recognized speech from an audio content time segment. The method also includes identifying k-phonemes, which occur within the phoneme sequence. The identified k-phonemes are stored within a data structure such that the identified k-phonemes are capable of being compared with k-phonemes from a search query. The subject of the disclosure relates generally to searching of rich media content. More specifically, the disclosure relates to an audio content search system, method, and computer-readable medium, that uses a phonetic matching and scoring algorithm to produce audio content search results. It is believed that the system and method have not been implemented in a working prototype and have not successfully addressed the lack of accuracy in the speech recognition model.

Another attempt to implement a method for searching non-text files is the “Blinkx” speech-recognition technology. Blinkx employs neural networks and machine learning using “hidden Markov models,” which is a method of statistical analysis in which the hidden characteristics of an item are guessed or estimated from what is known.

### SUMMARY OF THE INVENTION

The present invention provides a method for indexing video and audio content on the internet. The method comprises: searching the internet for files containing audio or video (A/V) content; obtaining text associated with a file containing A/V content; generating a first searchable index of the associated text with at least one of the title of the A/V file, a description of the A/V content, a URL link to the A/V file, and timing information of the associated text in relation to the A/V content; storing the first searchable index in a database; processing audio of files that do not contain associated text through a speech-to-text recognition module to generate first processed associated text; generating a second searchable index of the first processed associated text with at least one of the title of the A/V file, a description of the A/V content, a URL link to the A/V file, and timing information of the processed associated text in relation to the A/V content; storing the second searchable index with the searchable first index in the database; and making the first and second searchable indexes stored in the database available to users who submit search request terms to be matched with the associated text and first processed associated text in the database.

The present invention further provides a video and audio internet search engine comprising an indexer, a speech-to-text recognition engine, a database coupled to the indexer, a user interface, and a matching engine. The indexer is configured to: search the internet for files containing audio or video (A/V) content; obtain text associated with a file containing A/V content; and generate a first searchable index of the associated text with at least one of the title of the A/V file, a description of the A/V content, a URL link to the A/V file, and timing information of the associated text in relation to the A/V content. The speech-to-text recognition engine is configured to process audio of files that do not contain associated text through a speech-to-text recognition module to generate first processed associated text. The indexer is further configured to generate a second searchable index of the first processed associated text with at least one of the title of the A/V file, a description of the A/V content, a URL link to the A/V file, and timing information of the processed associated text in relation to the A/V content. The database is configured to store the first and second searchable indexes. The user interface is configured to receive search request terms for a user. The matching engine is configured to: search the database in an attempt to match the received search request terms with the associated text and the first processed associated text; and provide results of the search to the user.

### BRIEF DESCRIPTION OF THE DRAWINGS

FIG. 1 illustrates a prior art, conventional search engine process;

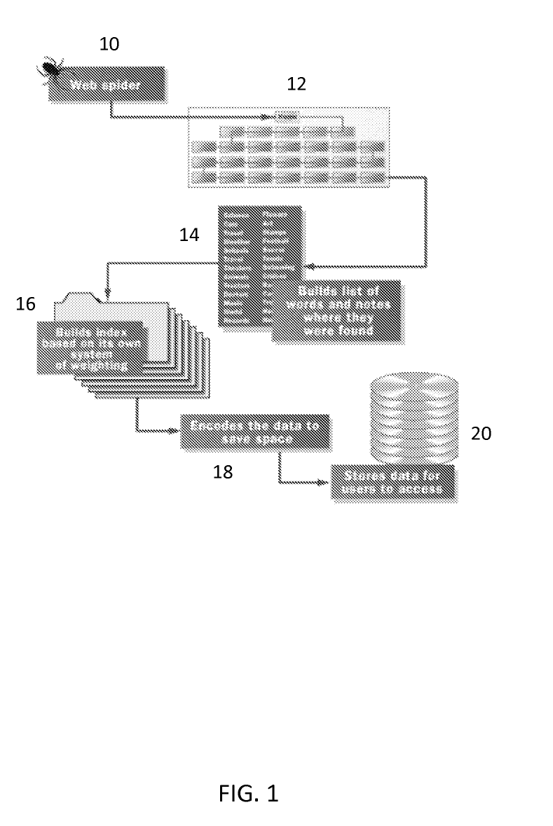

FIG. 2 is a block diagram representing embodiments of a A/V search engine of the present invention;

FIG. 3 is a flowchart of one aspect of the A/V search engine of FIG. 2; and

FIG. 4 is a flowchart of another aspect of the A/V search engine of FIG. 2.

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

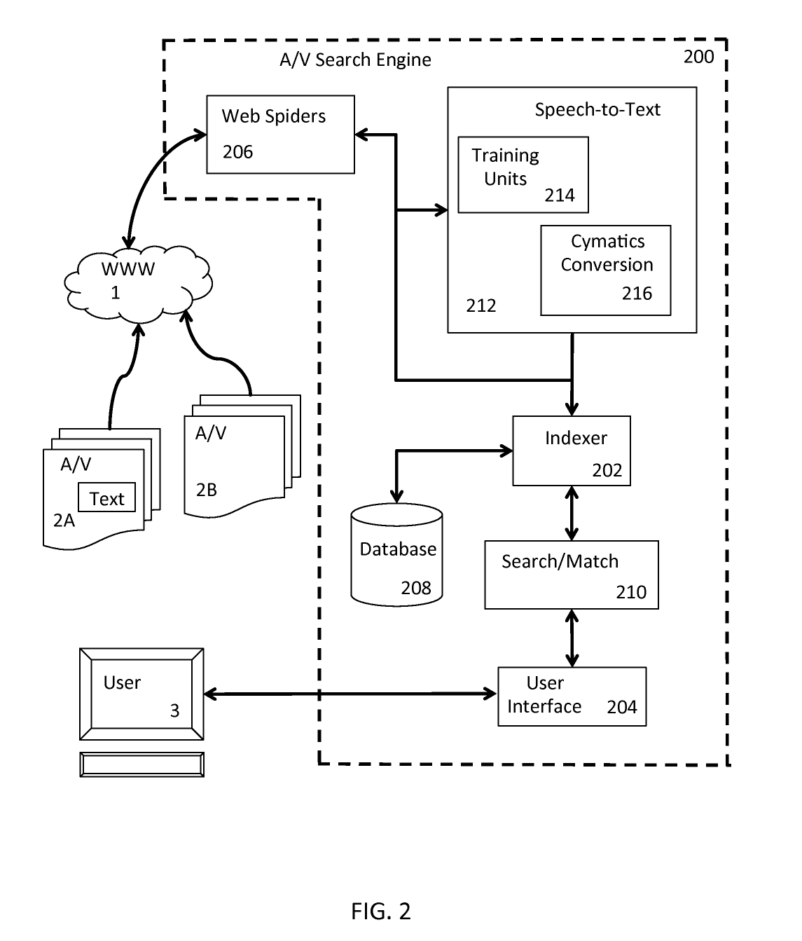

Embodiments of the present invention provide an internet service that enables users to search the content of audio and video files for specific words or phrases in a manner that is similar to searching for words or phrases in written text. However, no longer will users be limited to receiving search results that are based on file titles or descriptions that are associated with such files. FIG. 2 is a block diagram representing embodiments of a search engine 200 of the present invention. Information about audio and video files 2A, 2B (collectively “2”) is obtained and stored in a search engine database 208. A user 3 may submit a search request to the search engine 200, which applies the search criteria against the information stored in the database 208. The results of the search, comprising matches which may be ranked by how close they meet the search criteria, are then presented to the user 3.

More specifically, in the embodiment of FIG. 2, the search engine 200 includes an indexer 202 and a user search interface 204. Spiders 206 directed by the indexer 202 search the Web 1 for audio and video files or content (referred to herein as “A/V”) 2. The spiders 206 search, not just for titles and descriptions, but also for files 2A having associated or attached text, such as subtitles, captions, transcripts, or lyrics (collectively referred to herein as “associated text” or “text”). The associated text is indexed in the same way as content that is found in a text file. The indexed information is then stored in a data structure, such as a database 208, allowing a user 3 to use the associated text as a primary search field.

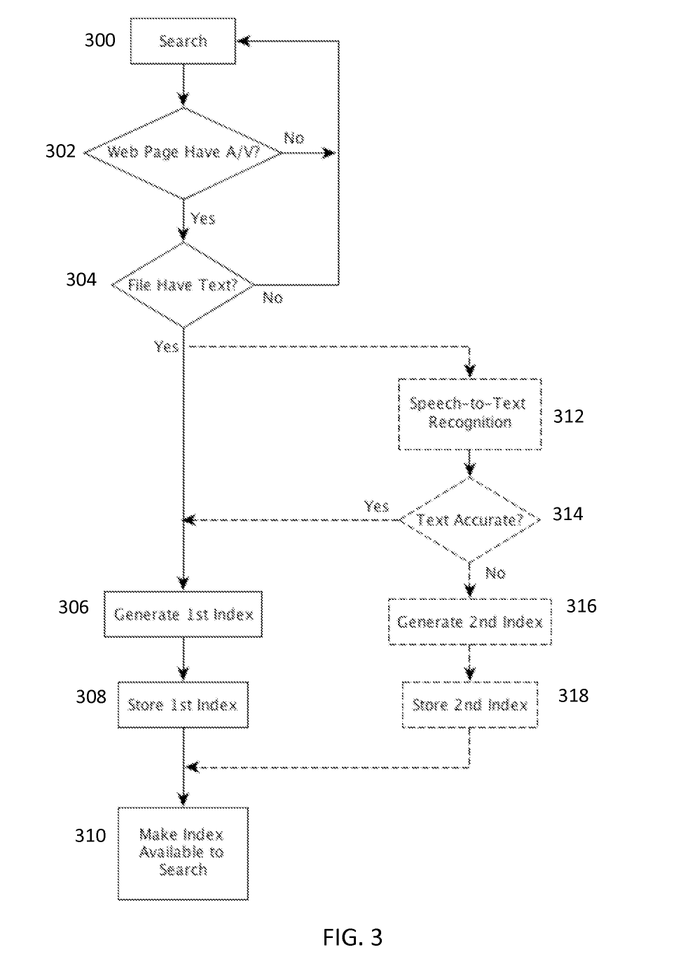

More specifically referring to FIG. 3, a spider 206 searches (step 300) a website based on a URL provided by the indexer 202. The spider 206 examines the first page of the website to determine whether the page includes any audio or video (step 302). If not, the spider goes to the next page of the website and continues until it locates a page with A/V content 2. If no such content is found in the pages of that website, the spider 206 continues the search of another website (step 300). When A/V content 2 is found, the spider 206 determines whether the A/V content has text associated with it 2A (step 304), for example subtitles associated with video content or lyrics associated with audio content. If not, the spider 206 continues its search (step 300) of the pages of the website or, if no such text is found on the website, moves to another website (step 300).

When text associated with A/V content is identified, that content is indexed by the indexer 202 (step 306) and stored in the database 208, along with the title of the A/V content, its description (if any), and the URL to link back to the webpage location of the A/V content (step 308) and made available for users 3 to search (step 310). When a user 3 submits a search query through a user interface 204 to the search engine 200, the search criteria are processed in a search and match module 210 through the indexer 202 by comparing them against the indexed text stored in the database 208. Full matches, as well as partial matches if desired, may be presented to the user 3 and may be ranked, such as by the number of times the search term(s) is/are found in the same A/V content. The results returned to the user 3 may also include the title and description of the A/V content, along with its URL link.

Unfortunately, most A/V files 2B do not have associated subtitles and many of the subtitles of those that do are not accurate or are not accurately time-synchronized with the audio or video itself. Therefore, the indexer 202 may optionally be coupled to an automatic speech-to-text recognition module 212 to process A/V files 2B that do not have associated content or whose accuracy is in question. Audio is downloaded, converted to a WAV or other appropriate format if necessary, and input to the module 212 (step 312). The module 212 processes the speech and outputs corresponding text that is time-synchronized to the audio or video. Optionally, a comparison may be made against original associated text, if any, to assess the accuracy of the original associated text (step 314). If the newly generated text matches at least a predetermined percentage, such as 50%, of the original associated text, then the original associated text is transferred to the indexer 202 to be indexed (step 306), stored in the database 208 with appropriate identifiers (step 308), and made searchable by users 3 (step 310). Otherwise, the newly recognized text is assumed to be more accurate than the associated text and is indexed (step 316), stored in the database 208 with appropriate identifiers (step 318), and made searchable by users 3 (step 310).

Conventional speech-to-text recognition programs require a training period in which a person reads text that is being displayed on a computer screen. The program stores the text with the sound and uses the text/sound pair (letter, word, phrase, sentence) for future recognition. It will be appreciated that such a process requires significant user participation and, for the results to be universally useful, many different voices should be used during the training process.

Use of the speech-to-text module in this embodiment entails downloading and converting every A/V file, both steps requiring massive computing resources to execute and process. Furthermore, even with proper training, current speech-to-text programs have significant accuracy issues, with accuracy rates only in the neighborhood of about 40%. While an individual may be able to train a speech recognition program to recognize his/her particular speech (accent, volume, timbre, speed, etc.), the same word or phrase may not be recognized as being the same when it is found in different A/V files and spoken or sung by different people in different environments using different sound systems.

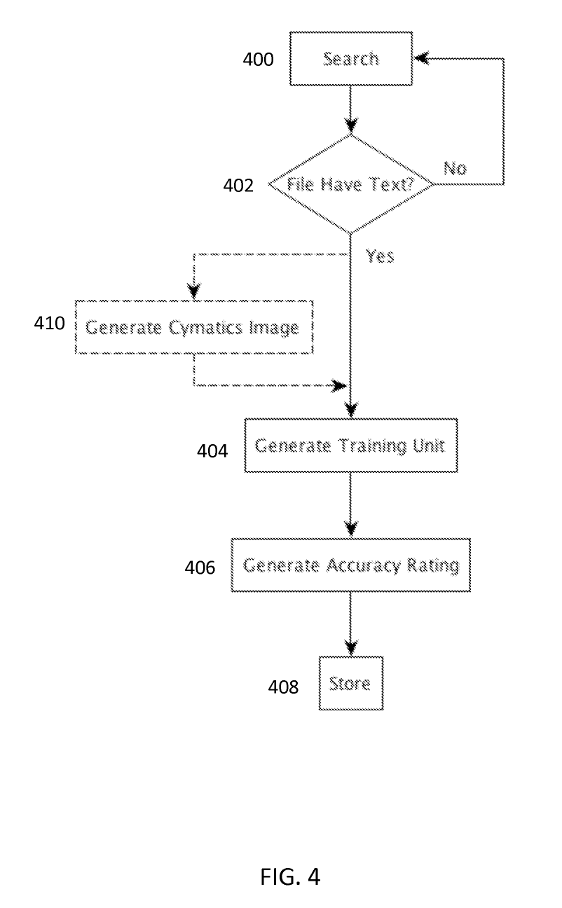

The In a further embodiment of the present invention (FIG. 4), speech-to-text recognition training may be accomplished in the existing speech-to-text module 212 by using A/V files 2A that have associated text (subtitles, lyrics, etc.). The spiders 206 again search (step 400) for A/V files with associated text (step 402). If a file does not have associated text, the search continues (step 400). For the files that do have associated text, training units 214 are created (step 404). Using many different such A/V files 2A increases the accuracy and universal applicability by matching many different voices to a single letter, word, phrase, or sentence (“text unit”) to create and store a training pair or unit. The indexer 202 may use statistics to indicate the probability that a particular text unit accurately represents an input sound (step 406). The training units 214 and accuracy ratings are then stored in the indexer 212 step 408). In trials, accuracy has been as high as 60%, a significant increase.

Further, the spiders 206 directed by the indexer 202 locate web pages having A/V content 2. However, instead of downloading the A/V files 2 from the web page, the A/V file 2 is played and the audio intercepted. The audio is processed through the trained speech-to-text recognition module 212 in real time, which may be performed at high speed. Thus, it is not necessary to download or store any portion of the A/V file 2. After being processed, the resulting text (subtitles, lyrics, etc.) is stored with appropriate time stamps that are synchronized to the original A/V content.

In this embodiment, the search engine 200 may again include three major modules:

1) The web archiving indexer 202, having the ability to play media from its original source without storing or copying the file.

2) The speech-to-text recognition module 212, responsible for converting speech in the played video and audio played by the indexer 202 into text and returning the recognized text to be stored in the database 208. The recognition process may include fetching the subtitle file for each video, if any, converting each sound and each subtitle, and then storing the data with the text in the database 208.

3) The user interface 204 with a searching and matching module 210, responsible for receiving a search query from the user 3, using the indexer 202 to match the query with the associated text in the database 208, and returning matching search results.

In general, a conventional speech-to-text engine includes an acoustic dictionary, a sound filtration model, and sound matching module. Existing research attempts to develop a better acoustic dictionary, better filtration, and better sound matching techniques, in order to reach the ideal, though unattainable, perfect speech to text recognition. However, due to the non-availability of all human sounds in a single database to make the matching, efforts have fallen well short, although such a technique requires fewer training sounds and is more cost effective than creating more than one acoustic dictionary.

Solving the sound matching by generating two models for each sound would take untold hours if humans are used for the training, but a computer may be used to teach itself using artificial intelligence. The two models for each sound are:

1) A general model that will contain the sound in much bigger context, such as a letter in a specific word and a word in specific sentence; and

2) A private model that will contain a repetition for the same sound in different voices, different situations, and different times.

For training in this embodiment, a large number of video and audio files 2A (though as noted above, not all) include timely related subtitles, lyrics, and translations (associated text). As with the previous embodiment, the associated text of the videos and audios may be used as training materials for the acoustic dictionary. In a first step, video and audio files with their “.srt” separated subtitle files are collected. Next, the content of the video and audio files are divided into relatively large time-segments with durations of, for example, from 5 to 20 seconds. The general model may be used to recognize each sound in the large time-segments according to the corresponding associated text. After the recognition process, each sound is combined in the speech-to-text module 212 with the corresponding associated text and divided into smaller time-segments to make a pair called training unit 214. Each training unit 214 includes one sound and one corresponding text. Each training unit 214 may be entered to the private model according to the recognized text in the general model. In a last step, statistics are generated for each private model representing the probability of finding the same sound in the same sentence (general model) but in different voices. The training may be performed by the speech-to-text module 212 without any human intervention.

As an example, a particular section of audio, and associated text, may be, “Hi, my name is Shadi. What are you doing, are you working?” In a first cycle of the recognition system, the general model for each segment may use previous speech-to-text recognition technology and the private model for each sound would be empty. To begin the recognition process of the acoustic dictionary:

1) Divide the content of the A/V file and the associated “.srt” file into large time-segments. For example, the first segment may be “5:24>>Hi, my name Is Shadi>>5:39” and the second segment may be “5:40>>What are you doing, are you working>>5:50”.

2) The general model may be used to perform an initial recognition of the text and then the initial segments are divided into smaller time-segments.

3) The first recognized sound would be “Hi;” the other sounds would also be processed.

4) Each recognized text is paired with the corresponding sound as a training unit.

5) A new private model is created for the recognized text. For example, a new private model for the first sound “Hi” is created by inserting the sound/text pair “Hi” as the first training unit.

6) Statistics may be generated for the private model. The initial statistic is 0; however, if the same sound is found and recognized in a different A/V file, the statistic may increase, such as to 1.

If the recognition process fails to recognize a word, such as the name “Shadi,” a new general model may be automatically built for the sound “Shadi” and linked to the associated text “Shadi.” The next time the system finds the sound “Shadi” in a similar sentence, the word will be automatically recognized.

During experimentation, the accuracy of the foregoing speech to text technology approach was increased by about 15-20% over the accuracy of conventional methods. As the learning is continued, however, better results are expected to be obtained due to the automatic learning process. Each time the associated text in a new A/V file is recognized, the training units for the private and general models will increase. And, the generated statistics are expected to reflect increase the accuracy.

To avoid storing audio content as part of the training units, the speech-to-text module 212 may optionally include a “Cymatics” module 216 in which the audio units are converted into Cymatics sound images (FIG. 4, step 410). Cymatics is described in Wikipedia as “the study of visible sound co vibration, a subset of modal phenomena. Typically the surface of a plate, diaphragm, or membrane is vibrated, and regions of maximum and minimum displacement are made visible in a thin coating of particles, paste, or liquid. Different patterns emerge in the excitatory medium depending on the geometry of the plate and the driving frequency.” As part of the auto-learning/training process, a Cymatics sound image of an audio segment is made and stored with the associated text in the speech-to-text module 212. Additional Cymatics images of the same sound, but from a different source, may be made and stored with the associated text. Thus, multiple Cymatics images may be stored with the associated text of a single sound. Each image may be slightly different but still represent the same sound. And, because a Cymatics image of silence (such as between words or phrases) is blank, it is possible to account for, or even adjust, incorrect synchronization between audio and associated text.

In addition to being used to search for audio and video content, embodiments of the present invention may also be used for searching in the information networks and searching in computers files; voice command control for smart phones and cars; voice command control for doors and home systems; and voice command control for industrial machines, among others.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for indexing video and audio content on the internet, comprising:
searching the internet for files containing audio or video (A/V) content;
obtaining text associated with a file containing A/V content;
generating a first searchable index of the associated text with at least one of the title of the A/V file, a description of the A/V content, a URL link to the A/V file, and timing information of the associated text in relation to the A/V content;
storing the first searchable index in a database;
processing audio of files that do not contain associated text through a speech-to-text recognition module to generate first processed associated text;
generating a second searchable index of the first processed associated text with at least one of the title of the A/V file, a description of the A/V content, a URL link to the A/V file, and timing information of the processed associated text in relation to the A/V content;
storing the second searchable index with the searchable first index in the database; and
making the first and second searchable indexes stored in the database available to users who submit search request terms to be matched with the associated text and first processed associated text in the database.

2. The method of claim 1, further comprising, after obtaining the text associated with the file containing A/V content, determining the accuracy of the associated text relative to the A/V content.

3. The method of claim 2, wherein determining the accuracy of the associated text comprises:
processing the audio of the file that contains associated text through a speech-to-text recognition module to generate the first processed associated text;
comparing the first processed associated text with the associated text;
and:
if the associated text matches at least a predetermined percentage of the first processed associated text, generating the first searchable index of associated text; and
if the associated text does not match at least the predetermined percentage of the first processed associated text, generating the second searchable index of first processed associated text.

4. The method of claim 1, wherein, without engaging in the generating, storing, processing, generating, and storing steps, obtaining text associated with a file containing A/V content comprises:
playing the audio of all A/V files without storing A/V content;
processing the audio of all of the A/V files through a speech-to-text recognition module to generate second processed associated text;
generating a third searchable index of the second processed associated text with at least one of the title of the A/V files, a description of the A/V content, URL links to the A/V files, and timing information of the second processed associated text in relation to the A/V content; and
storing the third searchable index.

5. The method of claim 1:
further comprising, prior to searching the internet for files containing A/V content, training the speech-to-text recognition module, comprising:
searching the internet for files containing A/V content and having associated text;
generating training units, each training unit comprising a sound portion from the audio of the A/V content with its associated text;
for each training unit, generating a probability that the sound is accurately represented by the associated text; and
storing each training unit in the speech-to-text recognition module; and
wherein processing the audio of files that do not contain associated text through the speech-to-text recognition module comprises:
identifying sounds in the audio file that match sound portions in the training units; and
generating the first processed associated text from the text corresponding to the matched sounds.

6. The method of claim 5, wherein generating the training units comprises:
generating a Cymatics sound image for each sound portion from the audio of the A/V content; and
storing the Cymatics sound image with the associated text.

7. A video and audio internet search engine, comprising:
an indexer configured to:
search the internet for files containing audio or video (A/V) content;
obtain text associated with a file containing A/V content; and
generate a first searchable index of the associated text with at least one of the title of the A/V file, a description of the A/V content, a URL link to the A/V file, and timing information of the associated text in relation to the A/V content;
a speech-to-text recognition engine configured to process audio of files that do not contain associated text through a speech-to-text recognition module to generate first processed associated text;
the indexer further configured to generate a second searchable index of the first processed associated text with at least one of the title of the A/V file, a description of the A/V content, a URL link to the A/V file, and timing information of the processed associated text in relation to the A/V content;
a database coupled to the indexer and configured to store the first and second searchable indexes;
a user interface configured to receive search request terms for a user; and
a matching engine configured to:
search the database in an attempt to match the received search request terms with the associated text and the first processed associated text; and
provide results of the search to the user.

8. The video and audio internet search engine of claim 7, wherein the indexer is further configured to determine the accuracy of the associated text relative to the A/V content after obtaining the text associated with the file containing A/V content.

9. The video and audio internet search engine of claim 7, wherein the indexer is further configured to:
process the audio of the file that contains associated text through a speech-to-text recognition module to generate the first processed associated text;
compare the first processed associated text with the associated text;
and:
if the associated text matches at least a predetermined percentage of the first processed associated text, generate the first searchable index of associated text; and
if the associated text does not match at least the predetermined percentage of the first processed associated text, generate the second searchable index of first processed associated text.

10. The video and audio internet search engine of claim 7, wherein the speech-to-text recognition engine is further configured to, prior to the indexer searching the internet for files containing A/V content:
search the internet for files containing A/V content and having associated text;
generate training units, each training unit comprising a sound portion from the audio of the A/V content with its associated text;
for each training unit, generate a probability that the sound is accurately represented by the associated text; and
store each training unit.

11. The video and audio internet search engine of claim 10, wherein the speech-to-text recognition engine is further configured to:
generate a Cymatics sound image for each sound portion from the audio of the A/V content; and
store the Cymatics sound image with the associated text as a training unit.

12. The video and audio internet search engine of claim 11, wherein the speech-to-text recognition engine is further configured to process the audio of files that do not contain associated text by:
identifying sounds in the audio file that match sound portions in the training units; and
generating the first processed associated text from the text corresponding to the matched sounds.

13. The video and audio internet search engine of claim 7, wherein, the index is further configured to obtain text associated with a file containing A/V content by:
playing the audio of all A/V files without storing A/V content;
processing the audio of all of the A/V files through a speech-to-text recognition module to generate second processed associated text;
generating a third searchable index of the second processed associated text with at least one of the title of the A/V files, a description of the A/V content, URL links to the A/V files, and timing information of the second processed associated text in relation to the A/V content; and
storing the third searchable index.
